(19) United States
(12) Patent Application Publication
(10) Pub. No.: US 2008/0266111 A1
(43) Pub. Date: Oct. 30, 2008

(54) MERCHANDISE TAG WITH ALARMING FEATURES FOR SECURING TAG TO MERCHANDISE

(75) Inventors: Matthew R. Shute, Charlotte, NC (US); William J. Kozlowski, Tega Cay, SC (US); Christopher J. Fawcett, Charlotte, NC (US); Ronald M. Marsilio, Lake Wiley, SC (US)

Correspondence Address: SAND & SEBOLT, AEGIS TOWER, SUITE 1100, 4940 MUNSON STREET, NW, CANTON, OH, 44718-3615, US

(73) Assignee: CHECKPOINT SYSTEMS, INC., Thorofare, NJ (US)

(21) Appl. No.: 12/171,009

(22) Filed: Jul. 10, 2008

Related U.S. Application Data
(63) Continuation-in-part of application No. 11/320,092, filed on Dec. 28, 2005.

(51) Int. Cl. G08B 13/14

(52) U.S. Cl. 340/572.9

(57) ABSTRACT

A merchandising tag comprising a housing with a first compartment defined therein and having a door pivotally mounted thereon to selectively allow or prevent access to the first compartment. The first compartment is adapted to receive a price tag therein. The housing is also provided with an attachment mechanism which has at least one portion which extends outwardly away from the housing is adapted to engage the product. The tag includes at least one alarm system disposed within the housing. A locking mechanism is provided for simultaneously locking the moveable door to prevent access to the first compartment; securing the portion of the attachment mechanism to the product so that the housing is not detachable therefrom; and for arming the at least one alarm system. When the locking mechanism is engaged, any attempt to remove the tag from the product, open the door, or remove the product with attached tag from the store will result in a loud-attention getting sound being emitted from the housing. The locking mechanism is disengaged using a remote magnetic key.

### CROSS-REFERENCE TO RELATED APPLICATIONS

This application is a Continuation-in-Part of U.S. patent application Ser. No. 11/320,092 filed Dec. 28, 2005, the entire specification of which is incorporated herein by reference.

### BACKGROUND OF THE INVENTION

1. Technical Field

This invention generally relates to merchandising tags. More particularly, the invention relates to a security tag including an alarm. Specifically, the invention relates to a merchandising tag having a lockable compartment which is adapted to receive a price tag therein and which includes a locking mechanism that simultaneously locks the compartment, secures the tag to a product and alarms the tag.

2. Background Information

Theft is a multibillion dollar problem for the retailing industry. As a result, the industry has instituted various measures and used a variety of security devices to deter would-be thieves and to aid in preventing thieves from removing products from stores. These security devices have covered a wide range of products and retailing display systems.

One of the latest challenges faced by the retailing industry is the switching of price tags between cheaper merchandise and expensive merchandise of the same type and the subsequent legitimate purchasing of the now lower-priced expensive merchandise. It is virtually impossible for a cashier in a large retail store to know what price belongs to which merchandise. It is therefore relatively easy for a thief to take the tag off a cheaper leather jacket, for example, and reattach the same to an expensive leather jacket and then pay for the repriced jacket and leave the store undetected. This method of stealing greatly reduces the thief's risk of being caught and they can always feign ignorance of how the price tag became switched if, for some reason, the incorrect price for the expensive merchandise is detected. Once this stolen product has passed through the detectors at the store exit, it is beyond recovery without the aid of legal authorities.

There is therefore a need in the art for a merchandising tag which will prevent price tag switching between products, which will alert store employees to the fact that the tag has been switched, will activate the door alarms positioned at the store exit and, furthermore, will continue to alert store employees and others of the theft even after the product has been removed from the store.

### SUMMARY OF THE INVENTION

The device of the present invention is a merchandising tag comprising a housing with a first compartment defined therein. A door is pivotally mounted on the housing to selectively allow or prevent access to the first compartment. The first compartment is adapted to receive a price tag therein. The housing is also provided with an attachment mechanism which has at least one portion that extends outwardly away from the housing is adapted to engage the product. The tag also has at least one alarm system disposed within the housing. A locking mechanism is provided for simultaneously locking the moveable door to prevent access to the first compartment; securing the portion of the attachment mechanism to the product so that the housing is not detachable therefrom; and for arming the at least one alarm system. When the locking mechanism is engaged, any attempt to remove the tag from the product, open the door, or remove the product with attached tag from the store will result in a loud-attention getting sound being emitted from the housing. The locking mechanism is disengaged using a remote magnetic key.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front elevational view of a merchandising tag in accordance with the present invention;

FIG. 2 is a rear elevational view of the merchandising tag of FIG. 1;

FIG. 3 is a side elevational view of the merchandising tag in the open position with a price tag being inserted therein;

FIG. 3A is a cross-sectional enlargement of the highlighted area of FIG. 3;

FIG. 4 is a side elevational view of the merchandising tag in the closed position

FIG. 4A is a cross-sectional enlargement of the highlighted area of FIG. 4;

FIG. 5 is a partial cross-sectional elevational view of the upper section of the rear housing with the tag in an unlocked state;

FIG. 6 is a partial cross-sectional elevational view of the upper section of the rear housing showing the bayonet being inserted into the slider;

FIG. 7 is a perspective view of the slider;

FIG. 8 is a perspective view of the spring clip which engages the spring pockets of the slider of FIG. 7;

FIG. 9 is a cross-sectional side view of the door latching mechanism through line 9-9 of FIG. 6;

FIG. 10 is a cross-sectional top view of the slider engaged with the spring clip and taken through line 10-10 of FIG. 6;

FIG. 11 is partial cutaway front view of the upper section of the front housing showing the locking mechanism being engaged;

FIG. 12 is a partial cross-sectional elevational view of the rear housing showing the locking mechanism engaged;

FIG. 13 is a cross-sectional side view of the latching mechanism through line 13-13 of FIG. 12 and showing the latch in locked position;

FIG. 14 is a cross-sectional top view of the slider through line 14-14 of FIG. 12;

FIG. 15 is a partial cutaway rear view of the rear housing showing the key engaging in the same;

FIG. 16 is cross-sectional top view of the slider with the locking mechanism being disengaged by the key;

FIG. 17 is a front elevational view of a second embodiment of a merchandising tag in accordance with the present invention;

FIG. 18 is a rear elevational view of the merchandising tag of FIG. 17;

FIG. 19 is a front elevational view of the merchandising tag with the door in an open position for insertion or removal of the price tag;

FIG. 20 is a top perspective view of the slider used for locking the merchandising tag;

FIG. 21 is a bottom perspective view of the slider of FIG. 20;

FIG. 22 is a partial front view of the merchandising tag with the front wall removed and the slider exploded away from the tag and having the bayonet in a disengaged position;

FIG. 23 is a partial front view of the merchandising tag with the front wall removed and showing the bayonet being engaged therewith;

FIG. 24 is a cross-sectional view of the merchandising tag showing the door in a locked position;

FIG. 25 is a cross-sectional side view of the merchandising tag with the bayonet engaged and the slider in a locked position;

FIG. 26 is a partial cross-sectional bottom view of the merchandising tag showing the bayonet in a locked position;

FIG. 27 is a front view of the merchandising tag with the front wall removed and the slider moved into a position to unlock the bayonet for removal;

FIG. 28 is a cross-sectional bottom view of the merchandising tag with the door in the open position and the tag ready for insertion or removal;

FIG. 29 is a cross-sectional side view of the merchandising tag showing the clamping member in the open position for removal of the bayonet; and

FIG. 30 is a cross-sectional end view of the merchandising tag showing the clamping member in the open position for removal of the bayonet.

### DETAILED DESCRIPTION OF THE INVENTION

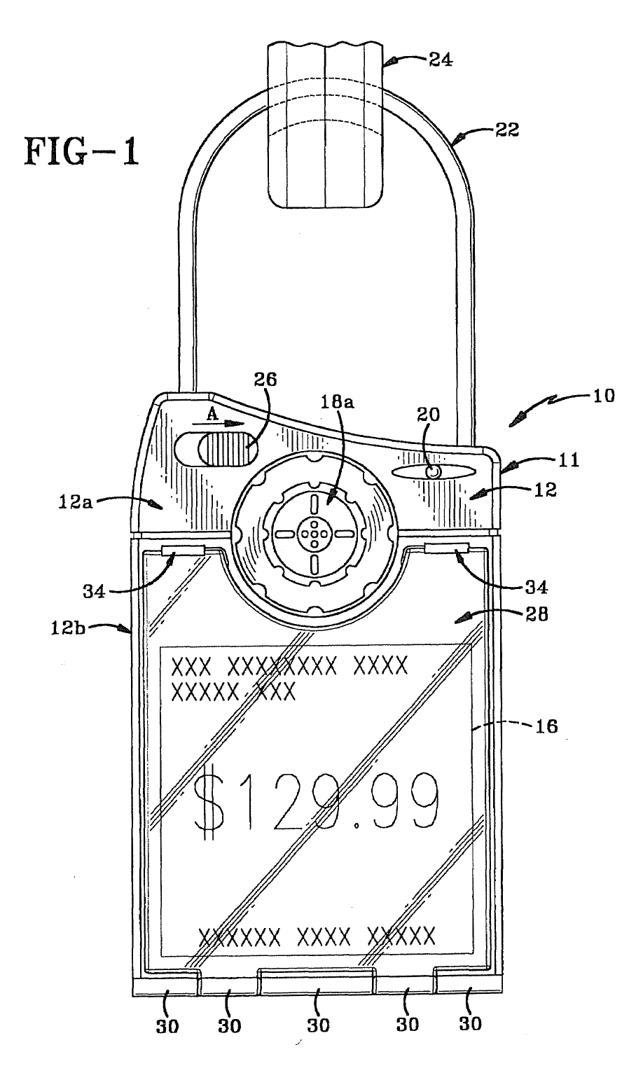

Referring to FIGS. 1-6 there is shown a merchandising tag in accordance with the present invention and generally indicated at 10. Tag 10 comprises a housing 11 having a front 12 and a back 14. Housing 11 is designed to hold a price tag 16 and house the indicators which display to the consumer that merchandising tag 10 is alarmed. Front 12 therefore includes a grill 18a for a speaker 18 (FIG. 5) to show the consumer that tag 10 will emit a sound if tampered with and a LED light 20 (light-emitting diode) which shows the consumer that tag 10 is actively alarmed. A cable 22 extends outwardly away from housing 11 and is releasably connects tag 10 to a product 24 as will be hereinafter described.

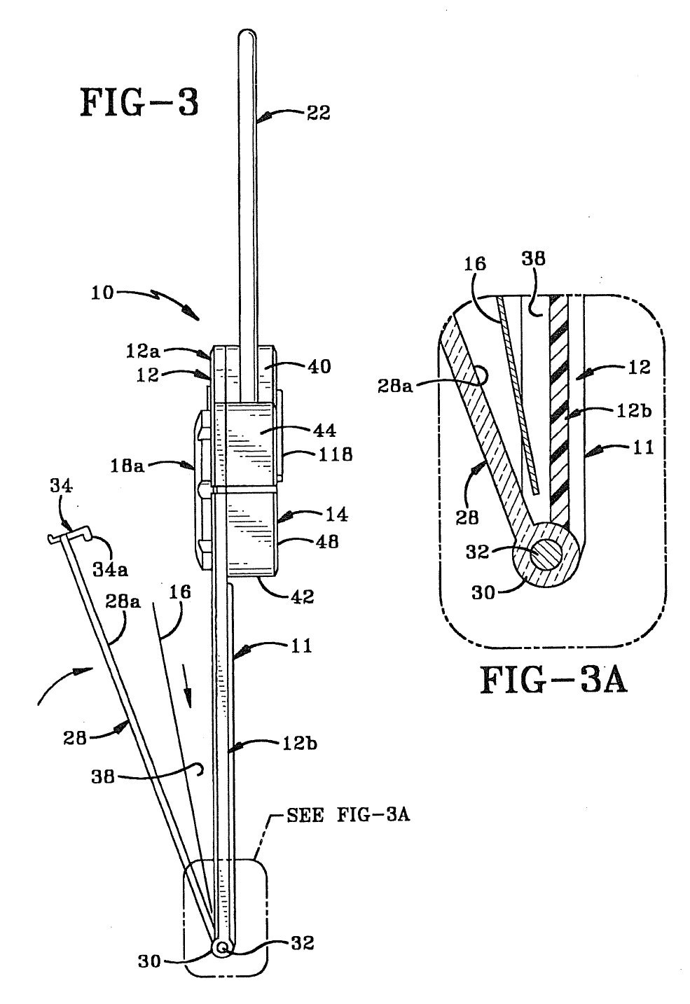

Front 12 includes an upper section 12a and a lower section 12b. A slider button 26 and the LED 20 are positioned on upper section 12a. Slider button 26 is used to engaging a locking mechanism 59 (FIG. 5) that is disposed within housing 11 as will be hereinafter described. A sound-emitting speaker 18 is disposed partially in upper section 12a and partially in lower section 12b and projects slightly outwardly from front 12 (FIG. 3). Speaker 18 is mounted in such a manner so as to prevent it from being tampered with to deactivate it or pried off front 12 by a would-be thief.

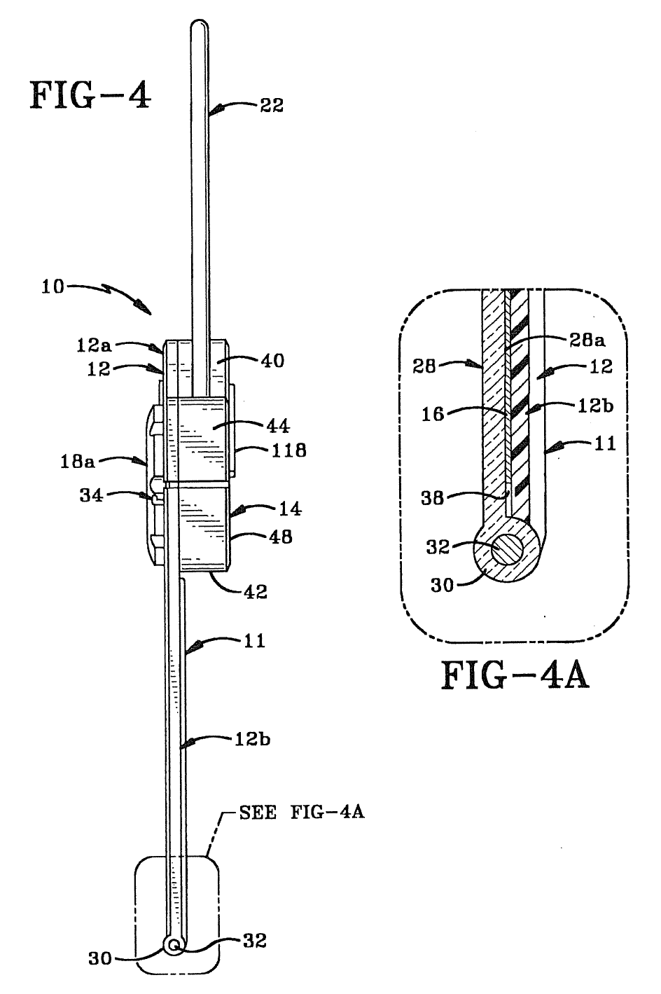

In accordance with a specific feature of the present invention, a door 28 is pivotally connected to the lower section 12b of front 12. The bottom ends of both door 28 and lower section 12b are shaped to form hinge sections 30 and a hinge pin 32 is inserted therethrough to pivotally secure door 28 and lower section 12b together. The upper end of door 28 includes a pair of latching members 34 each having a projection 34a that is receivable through an aperture 36 in front 12. A first compartment 38 is defined between the inner surface 28a of door 28 and the outer surface of the front 12 of housing 11. Door 28 is moveable between an open position (FIG. 3) permitting insertion or removal of price tag 16 in first compartment 38, and a closed position (FIG. 4) preventing insertion or removal of price tag 16 from first compartment 38. When merchandising tag 10 is locked (as will be later herein described), latching members 34 are locked into place so that door 28 cannot be moved into an open position to allow access to first compartment 38. When tag 10 is unlocked, door 28 can be moved into an open position to allow access to first compartment 38.

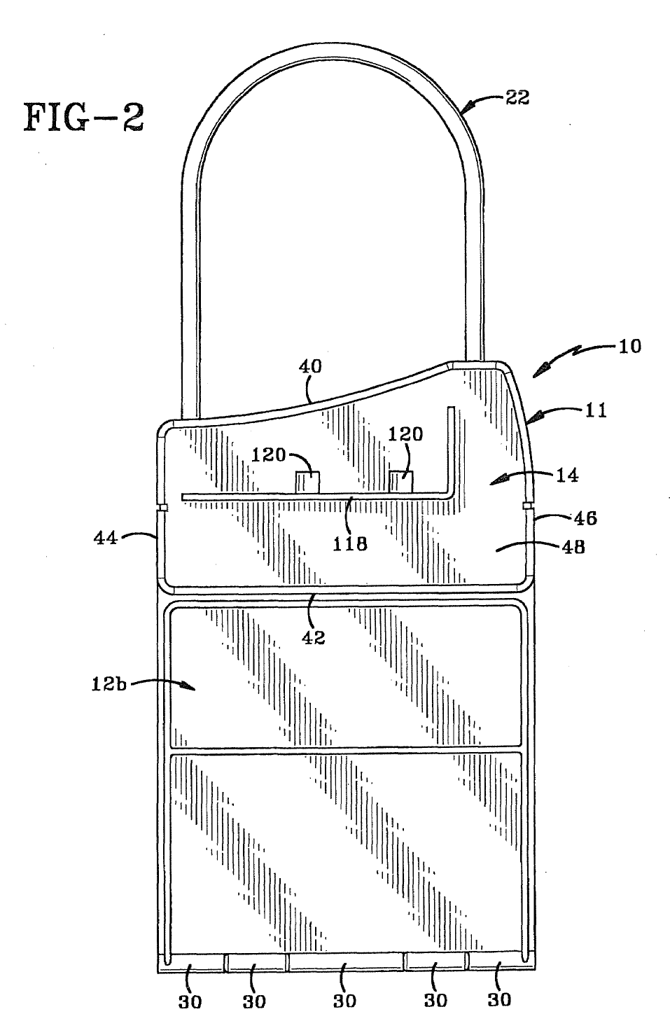

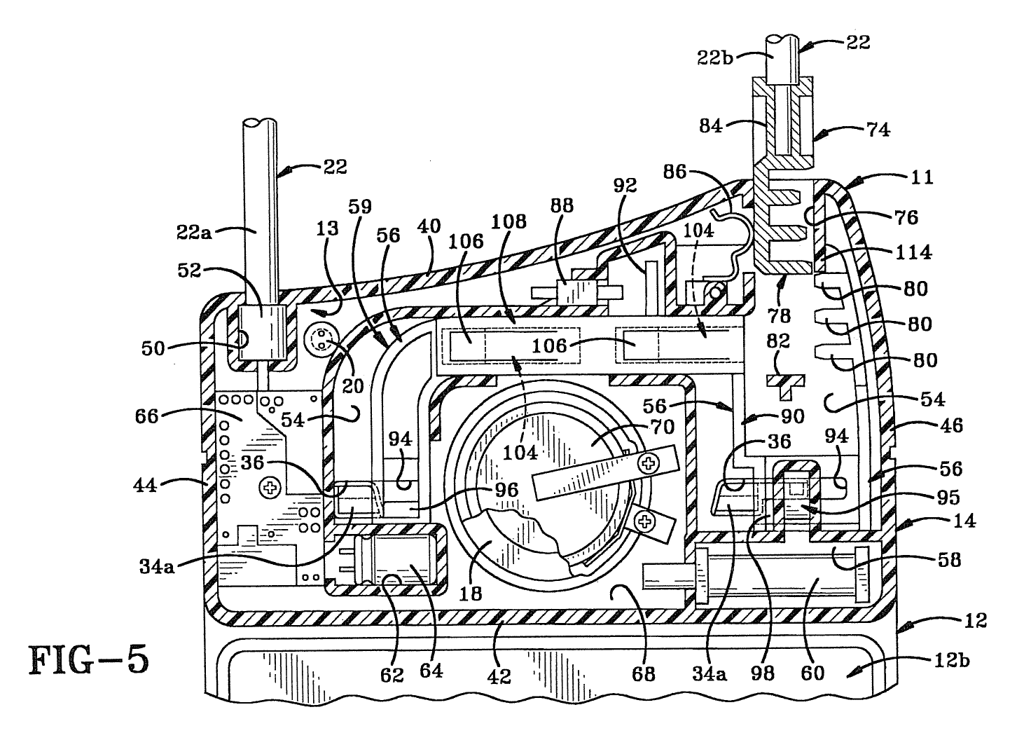

Back 14 of housing 11 is shown in greater detail in FIGS. 5-6. Back 14 defines a second compartment 13 having an upper wall 40, a lower wall 42, two side walls 44, 46 and a back wall 48 (FIG. 2). Back 14 is also fabricated with a number of internal walls which form differently shaped areas to hold the components of locking mechanism 59 and a three-way alarm system. A first area 50 is formed proximate the upper and side walls 40, 44 of back 14. Area 50 is designed to fixedly hold a ferrule 52 connected to a first end 22a of cable 22.

A second area 54 is formed approximately in the middle of back 14 and is shaped to receive a slider 56 and spring clip 108 of locking mechanism 59. Second area 54 is configured to allow slider 56 to move back and forth therein. Slider 56 is used to lock merchandising tag 10 and to activate the alarm systems.

A third area 58 is formed in back 14 to house an EAS tag 60. Tag 60 is adapted to trigger a remote alarm system at a store exit if a remote magnetic key (not shown) is not used to deactivate merchandising tag 10 prior to the customer exiting the store. It will be understood by those skilled in the art that any suitable EAS tag or RFID tag or any other alarm activating device may be used in merchandising tag 10 without departing from the spirit of the present invention.

A fourth area 62 is formed in back 14 to house a capacitor 64 and printed circuit board 66 and a fifth area 68 houses a battery 70 which provides power to merchandising tag 10.

Merchandising tag 10 is secured to a product 24 by way of cable 22. Cable 22 is fixedly secured at a first end 22a into housing 11 and is removably attachable at a second end 22b thereto. First end 22a of cable 22 is fixedly secured within ferrule 52 housed within first area 50. Neither the ferrule 52 nor the first end 22a of cable 22 can be withdrawn from back 14. Ferrule 52 is electrically connected with circuit board 66. Second end 22b of cable 22 is fixedly secured to a bayonet 74 which is removably received through an aperture 76 formed in upper wall 40 of housing 11. Aperture 76 allows access into second area 54 of back 14. Bayonet 74 is removably insertable through aperture 76 to engage with slider 56. Bayonet 74 has a generally E-shaped end 78. A stop 82 is provided in housing 11 to arrest the downward movement of bayonet 74 when it is inserted through aperture 76. Bayonet 74 further includes a substantially I-shaped region 84 which engages a contact 86 for a switch 88 when bayonet 74 is locked in place as will be hereinafter described.

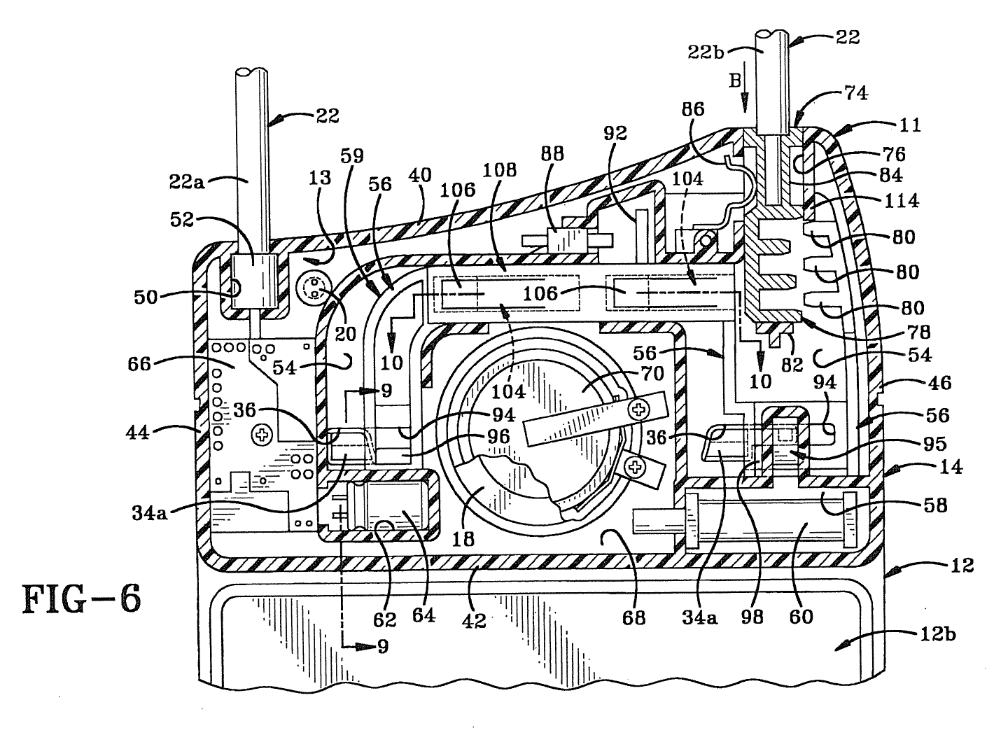

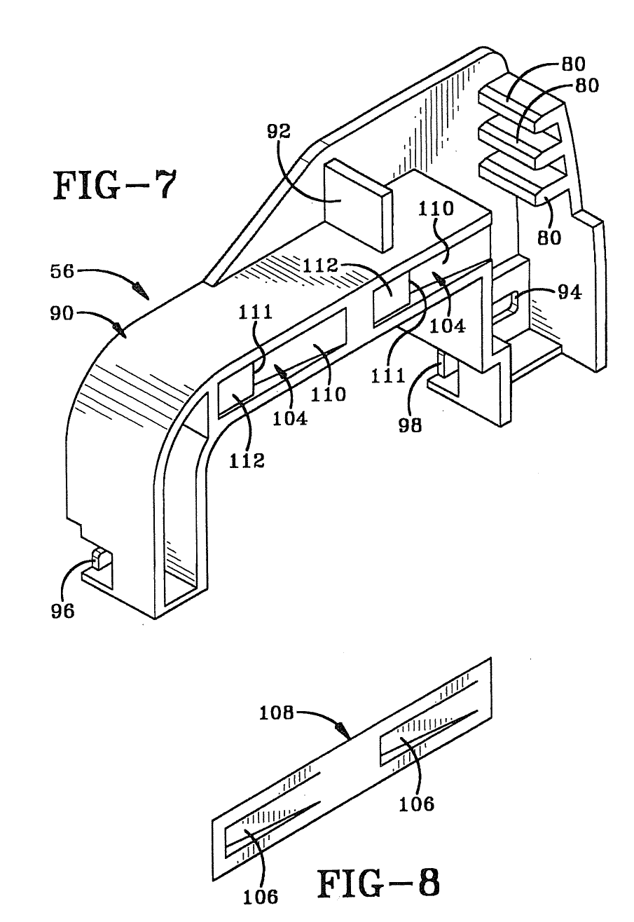

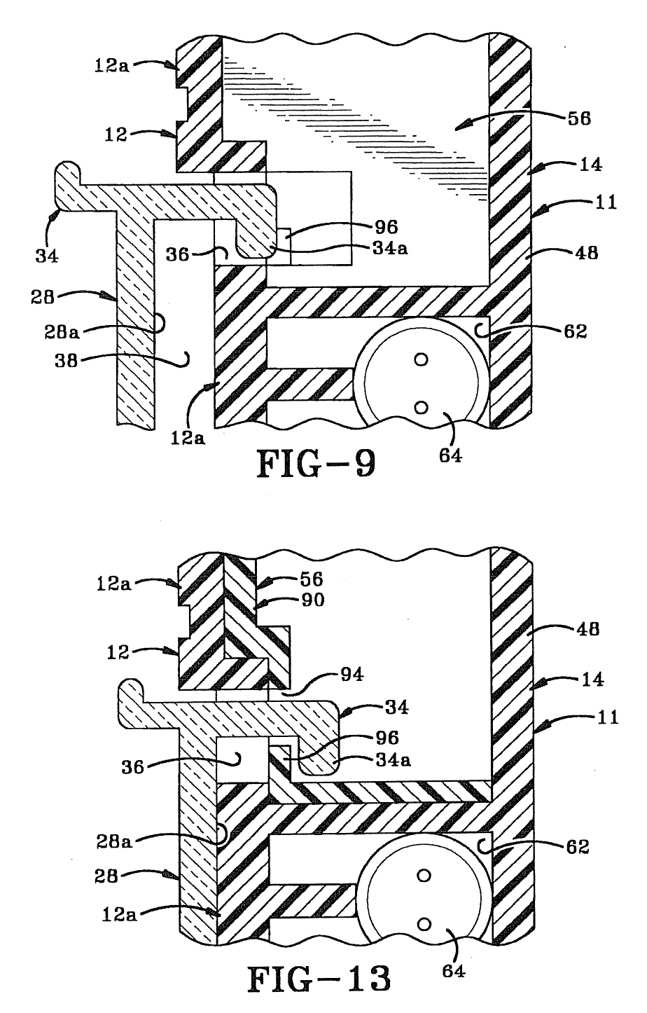

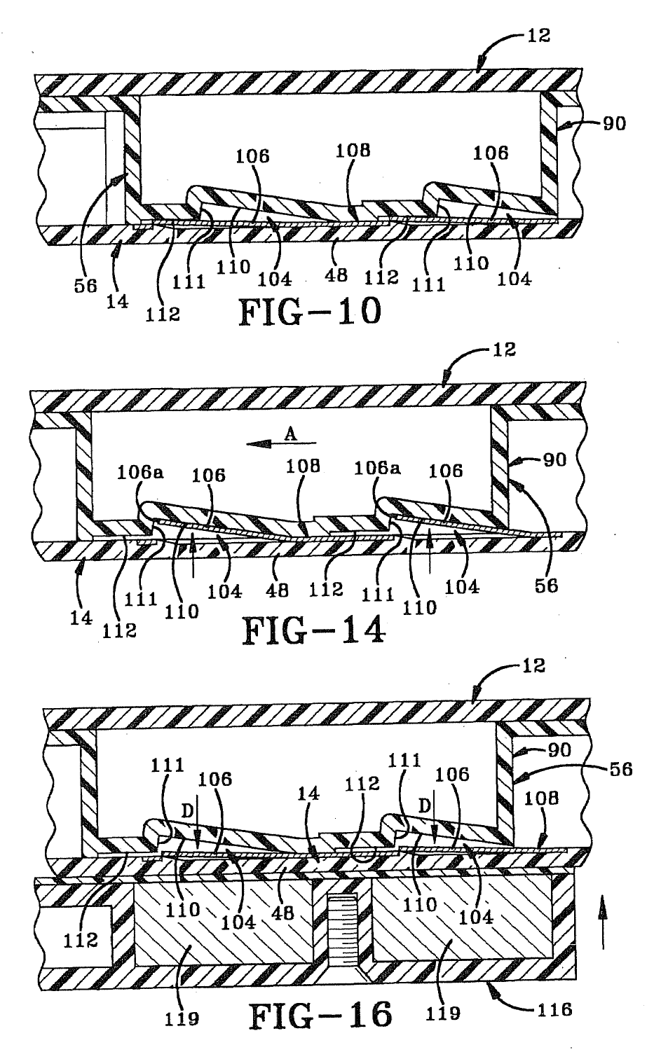

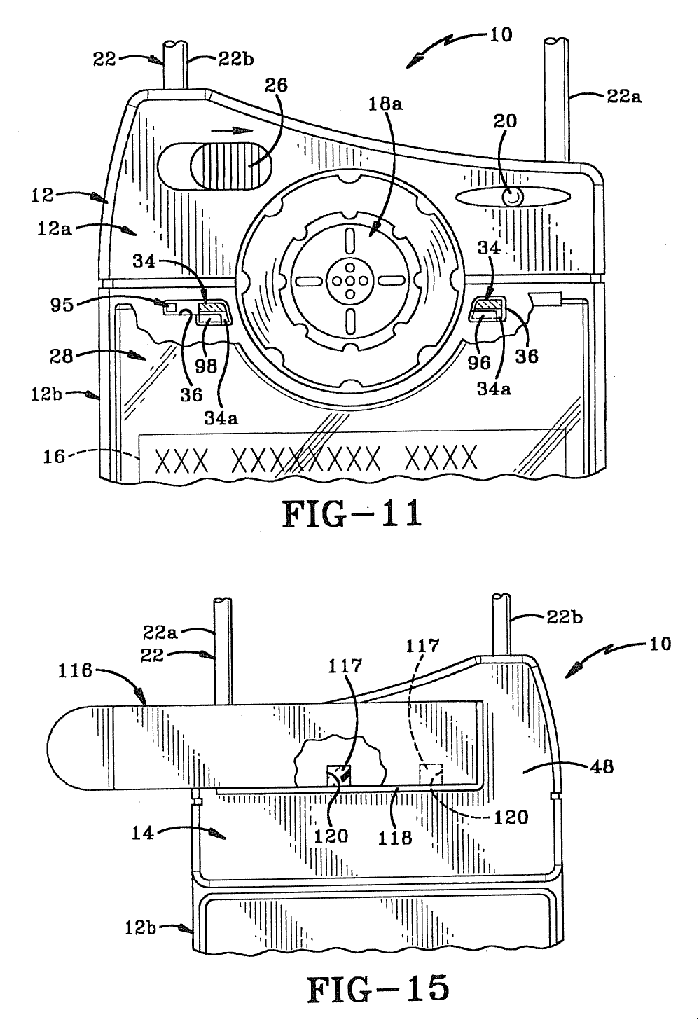

Slider 56 is shown in greater detail in FIGS. 7 & 8. Slider 56 comprises a body 90 shaped to be moveably received within second area 54. Locking teeth 80 are formed on body 90 and are shaped and spaced for engagement with the fingers of the E-shaped end 78 of bayonet 74. Body 90 also includes a switch activator 92 for engaging switch 88 (FIG. 5), recesses 94 for receiving latching members 34 of door 28 therethrough, a plunger switch 95 extends through aperture 36 and is activated by latching member 34 as member 34 is inserted through aperture 36 to activate the alarm system, and a pair of projections 96, 98 which slidably engage latching members 34 when slider 56 is moved into engagement with the same. Slider 56 further includes pockets 104 which receive arms 106 of spring clip 108 therein. As seen from FIGS. 7 & 8, spring clip 108 is a substantially planar member having arms 106 spring-biased outwardly out of alignment with the planar member. Pockets 104 in slider 56 include a first inclined face 110 (also seen in FIG. 10) which is complementary sized and shaped to receive arms 106 therein and a flattened second face 112. Pockets 104 each further include a third face 111 which arrests the movement of arms 106 when slider 56 is slidingly moved within second area 54 to lock merchandising tag 10. Spring clip 108 is manufactured from a magnetic metal while slider 56 preferably is manufactured from a nonmetallic or nonmagnetic material.

Merchandising tag 10 is used in the following manner to attach a price tag 16 to a product 24. Door 28 is disposed in an opened position (FIG. 3) in order for a price tag 16 to be inserted into first compartment 38 between door 16 and front 12 of housing 11. Door 28 is then moved into a closed position (FIG. 4) so that latching members 34 are received through apertures 36 in front 12. While the door 28 is now in a closed position, it is not locked into place, nor is tag 10 alarmed at this point. The store employee passes cable 22 around an appropriate member of the product 24 or product packaging and then inserts second end 22b of cable into aperture 76 in upper wall 40 (FIG. 5). Second end 22b of cable 22 is pushed downwardly in the direction of arrow “B” (FIG. 6) until end 78 encounters stop 82. At this point, I-shaped region 84 of bayonet 74 is urged, by contact 86, into engagement with the wall 114 defining aperture 76 (FIG. 6), and is thus held in place, but is not locked.

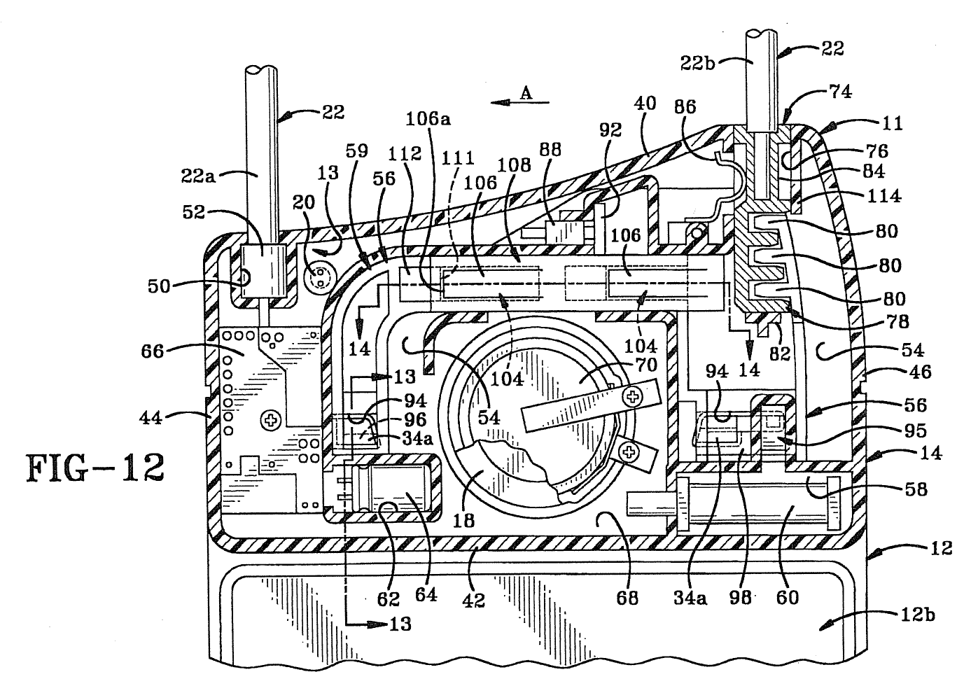

In order to lock door 28 in place and alarm tag 10, slider button 26 on front 12 is pushed in the direction of arrow “A” (FIGS. 1&12). Slider button 26 is operationally connected to slider 56 and, consequently, movement of slider button 26 in the direction of arrow “A” causes slider 56 to slide within second area 54 from a first position (shown in FIG. 6) to a second position (shown in FIG. 12). Referring to FIGS. 6, 9, 12 & 13, as slider 56 is moved by slider button (not shown in this figure) in the direction of arrow “A”, projections 96, 98 on slider 56 slide in second area 54 and are disposed between projections 34a of latching members 34 and rear wall 28a of door 28. Projections 34a thereby are locked in place in slider 56 and door 28 can therefore no longer be moved into an open position. Movement of slider 56 also causes arms 106 of spring clip 108 to slide into pockets 104 in slider 56 (FIG. 14), thereby allowing arms 106 to be spring-biased into contact with inclined first face 110 of pockets 104. If an attempt is made to move slider 56 in a direction opposite to arrow “A”, then the free ends 106a will engage third face 111 of pockets 104 and prevent any further movement in that opposite direction. Furthermore, movement of slider 56 in the direction of arrow “A” causes teeth 80 of slider 56 to interlock with the fingers on end 78 of bayonet 74, thus preventing bayonet 74 and end 22b of cable 22 attached thereto from being withdrawn out of aperture 76 in housing 11.

Movement of slider 56 from the first position (FIG. 6) to the second position (FIG. 12) also simultaneously closes the electric circuit (not shown) within tag 10 by causing switch activator 92 to contact switch 88. The wiring of tag 10 has not been shown in the attached drawings to simplify the same, but the wiring of such a device would be obvious to one of ordinary skill in the art. Power is provided to the electric circuit by battery 70. The closing of the electric circuit is evidenced by the illumination of LED 20 on front 12 of housing 11.

Slider 56 therefore simultaneously locks door 28 into the closed position, locks second end 22b of cable 22 into second area 54 of housing 11 thus preventing tag 10 from being detached from product 24 and activates one or more of the alarms disposed within housing, i.e., speaker 18 and EAS tag 60.

Referring to FIGS. 2, 15 & 16, merchandising tag 10 can only be deactivated using a specially designed remote magnetic key 116. Back wall 48 (FIG. 15) of housing 11 includes an L-shaped key guide 118 and has a pair of spaced-apart alignment holes 120 positioned adjacent key guide 118. Key 116 includes a pair of alignment posts 117 that are spaced apart to align with alignment holes 120 when key 116 is moved along key guide 118. When key 116 is correctly positioned, the magnets 119 in key 116 attract the arms 106 of spring clip 108 toward them. This attraction causes arms 106 to be withdrawn from pockets 104 in the direction of arrow “D” thereby causing arms 106 to move back into alignment with the planar portion of clip 108 (FIG. 16). The user can then move slider 56 in a second direction opposite to arrow “A”, thus causing projections 96 and 98 to slide out from between projections 34a of latching members 34. This allows door 28 to be moved from a closed and locked position to an open position. Secondly, movement of slider 56 breaks the electric circuit within housing 11, thus deactivating the alarm systems within tag 10. Finally, movement of slider 56 in the second direction disengages teeth 80 from the fingers of end 78. The second end 22b of cable 22 is then free to be withdrawn from housing 11 through aperture 76. Tag 10 can therefore be detached from product 24 without the alarms disposed in housing 11 being activated.

If, however, tag 10 is alarmed and a would-be thief attempts to open door 28 to tamper with price tag 16, then a loud, attention-getting sound is emitted by speaker 18. Furthermore, if an attempt is made to detach cable 22 and to thereby remove merchandising tag 10 from the product 24 to which it is attached, speaker 18 again emits a loud, attention-getting sound. This will also occur if cable 22 is cut. Furthermore, if an attempt is made to remove the product 24 from the store with the merchandising tag 10 still attached thereto, then the EAS tag 60 disposed within housing 11 will activate the remote store exit alarm as the product 24 is removed from the store. Furthermore tag 10 is designed that if the product 24 and attached tag 10 pass through the store exit alarms without being deactivated by way of a special key, the speaker 18 will start to emit a loud, attention getting sound and will continue to do so until battery 70 is drained. This sound from the tag 10 will therefore alert store employees and people out of the store that a product 24 has been stolen.

It will be understood by those skilled in the art that the merchandising tag could have a speaker on both the front and rear housings or at the top and/or bottom of the tag; and that the speaker, slider button, LED and door may be positioned differently on the merchandising tag without departing from the spirit of the present invention.

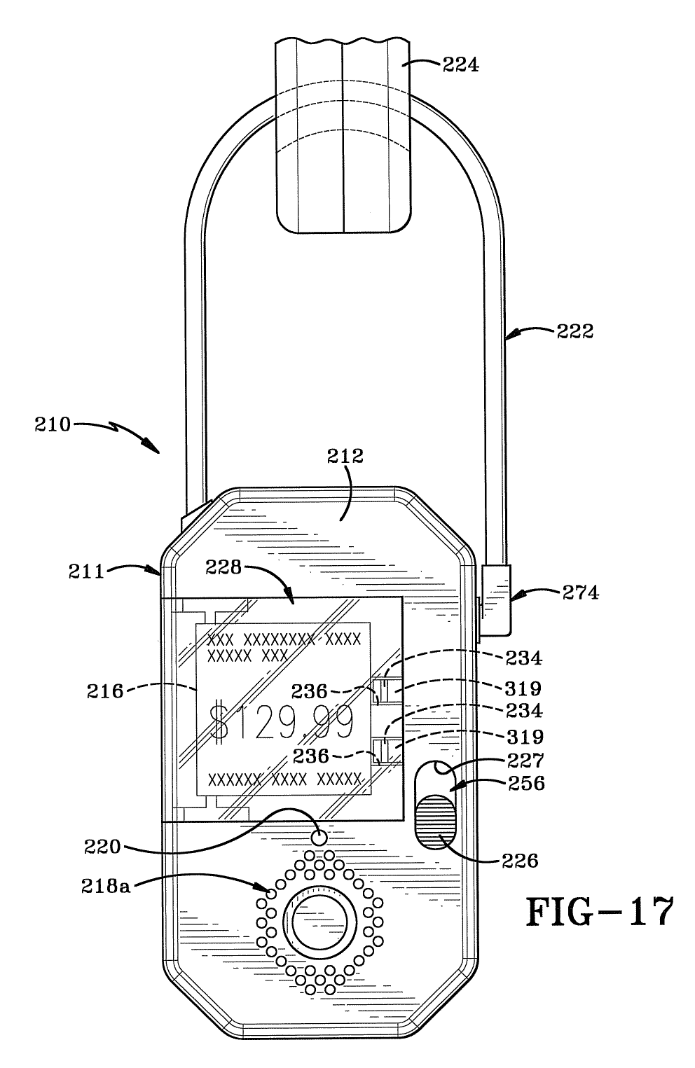

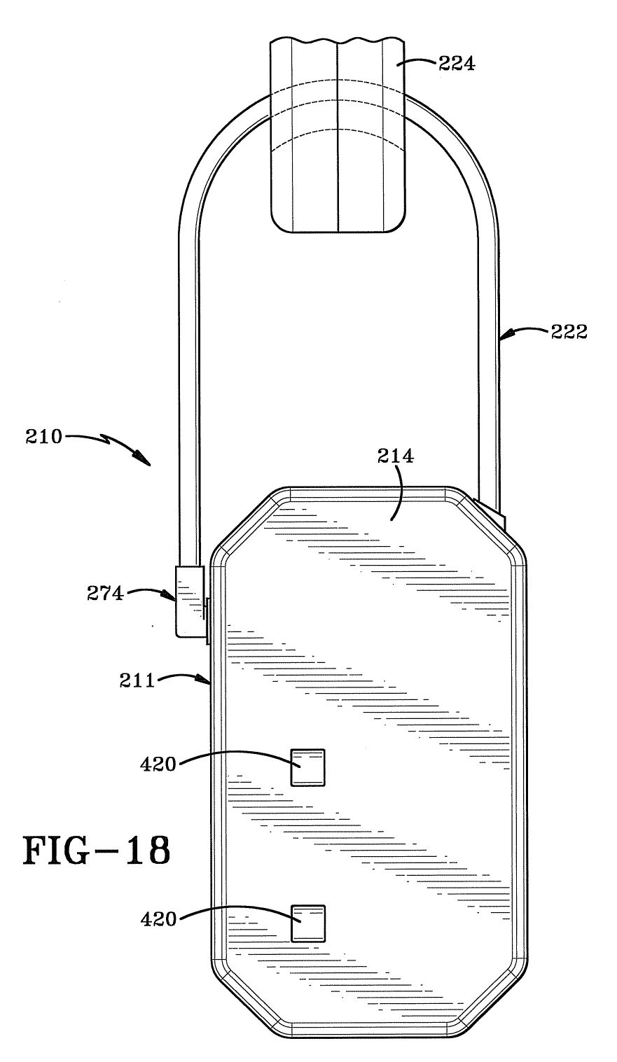

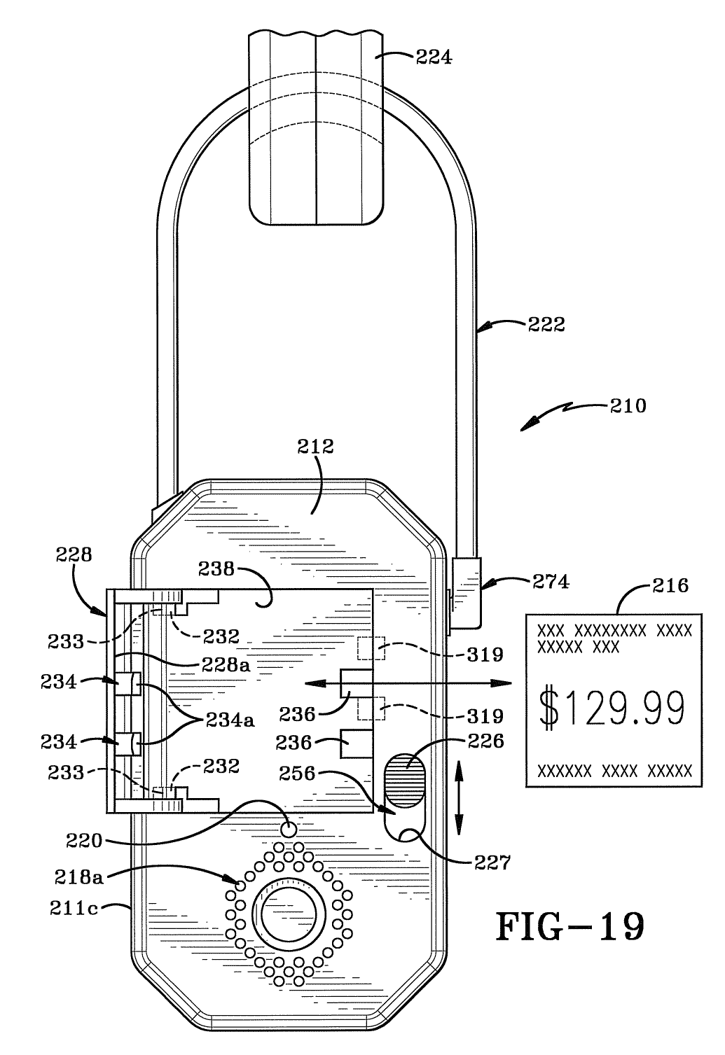

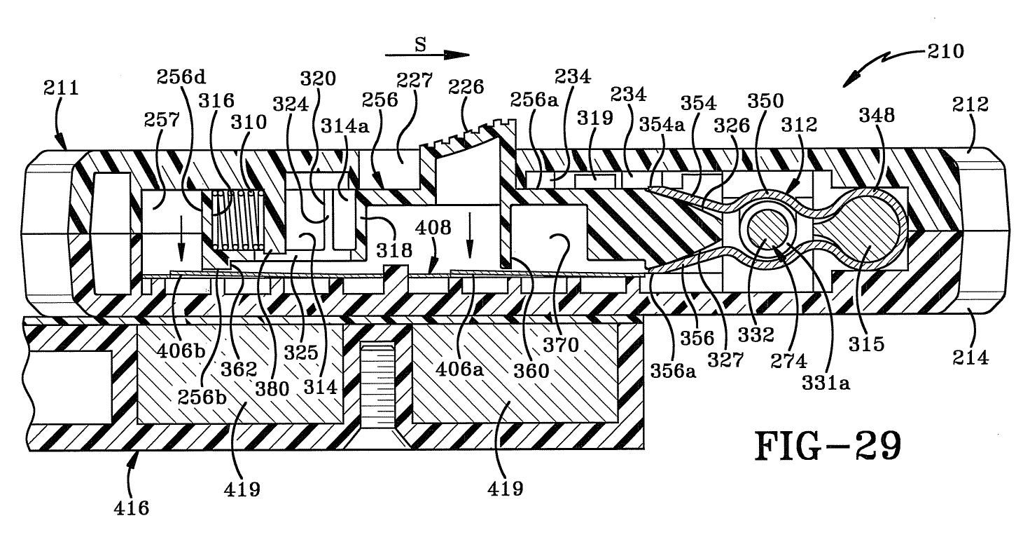

FIGS. 17-30 show a second embodiment of a merchandising tag in accordance with the present invention, said tag being generally indicated at 210. As with the first embodiment, merchandising tag 210 is designed to be secured to a product 224 to aid in preventing theft of the product and preventing removal or replacement of a price tag 216 that is attached to product 224. Merchandising tag 210 comprises a housing 211 having a front 212 and back 214 that are secured together. Housing 211 is designed to lock a price tag 216 therein and to house and protect the alarm components that aid in preventing theft of the product 224 or removal of the price tag 216. As with the previous embodiment, the alarm components may include, but are not necessarily limited to, a battery 270, a sound-producing speaker 218 and an RFID or EAS tag 260. Front 212 of housing 211 includes a grill 218a positioned adjacent speaker 218 and a LED light 220 that projects through a hole to indicate that the device is alarmed. A cable 222 extends outwardly away from housing 211 to secure tag 210 to product 224. While the drawings do not show the electrical circuitry that connects the various alarm components together, it will be understood that such circuitry is provided within housing 211 and through cable 222. Interruption of any of the circuits by attempting to cut or remove cable 222, prying open door 228 or attempting to remove product 224 from the store, will trigger one or more of the alarms retained within the housing. Merchandising tag 210 is designed to be unlocked and disarmed only through the use of a specially designed key 416 (FIG. 29).

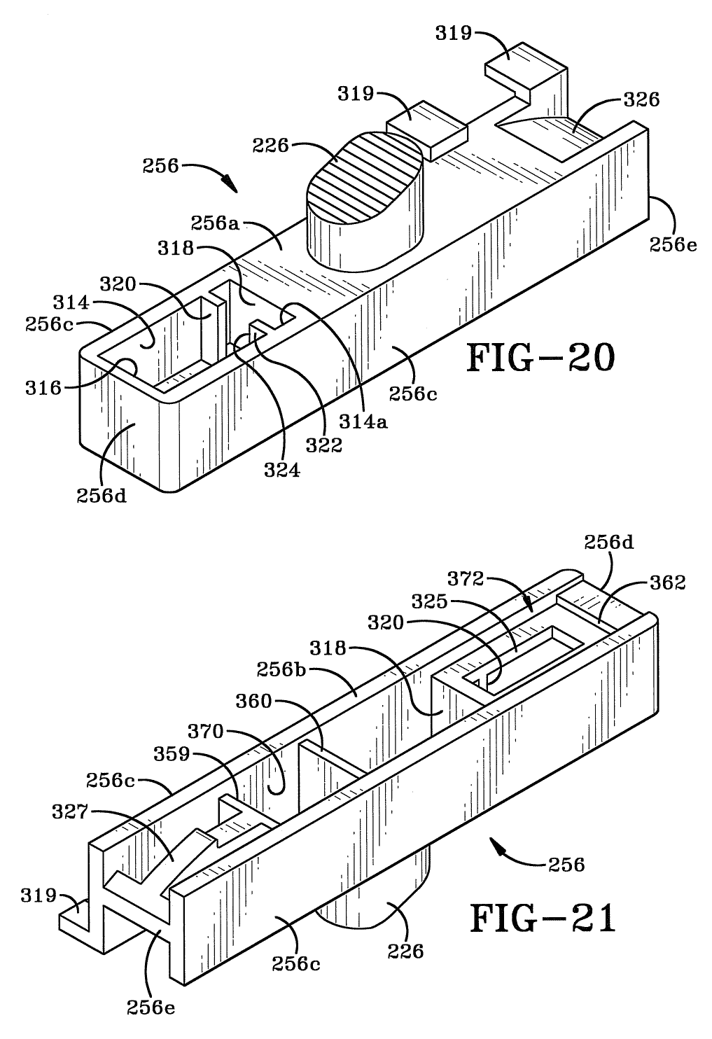

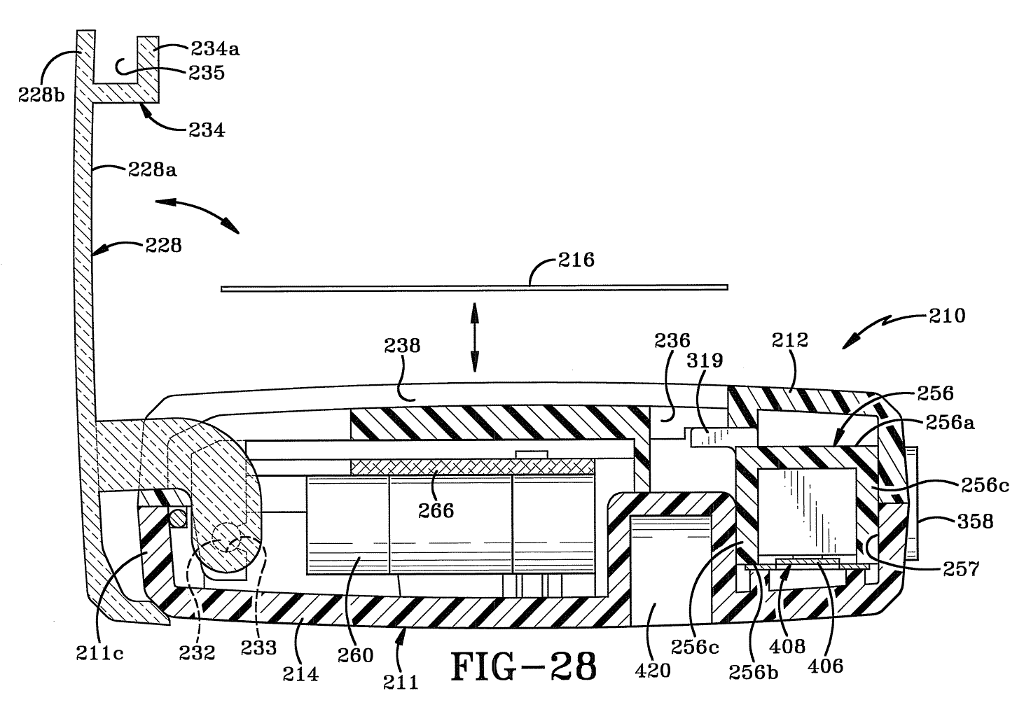

In accordance with a specific feature of the present invention, door 228 is hingedly connected to front 212 and is pivotable between a closed position (FIG. 17) and an open position (FIG. 19). As shown in FIG. 19, hinge pins 232 engage recesses 233 in front 212 a distance inwardly from side wall 211c. This distance substantially hinders a would-be thief from gaining direct access to hinge pins 232. A first compartment 238 is defined between door 228 and the outer surface of front 212. First compartment 238 is sized to receive price tag 216 therein. Door 228 is made from a transparent material so that price tag 216 is easily seen therethrough. When door 228 is in the open position, first compartment 238 is accessible and price tag 216 may be either inserted into or removed from first compartment 238. A pair of L-shaped latching members 234 (FIGS. 19 & 24) extend inwardly from an interior surface 228a of door 228 and are receivable into complementary apertures 236 in front 212 of housing 211. A leg 234a of each latching member 234 extends substantially parallel to the interior surface 228a of door 228 so that a gap 235 (FIG. 28) is defined therebetween.

When door 228 is in a closed position (FIG. 19), latching members 234 are received in apertures 236, however, simple application of finger pressure to door 228 will reopen the same, i.e., door 228 is only latched to front 212. A locking mechanism 259 is employed to lock door 228 to front 212 so that it cannot be pivoted from the closed position to the open position. The exact structure and functioning of locking mechanism 259 will be described in greater detail hereinafter. Locking mechanism 259 is, however, designed to engage leg 234a on each latching member 234 to lockably retain latching members 234 in apertures 236. Special key 416 must be employed to disengage locking mechanism 259 so that latching members 234 may be removed from apertures 236 and door 228 may be pivoted into the open position.

As previously mentioned, merchandising tag 210 is releasably secured to product 224 by cable 222. A first end 222a of cable 222 is fixedly secured within housing 211 and cannot be detached therefrom. A second end 222b of cable 222 is secured within housing 211 but is selectively detachable therefrom. Second end 222b of cable 222 is provided with a bayonet connector 274 that is complementary to a bore 334 in housing 211. FIG. 22 shows bayonet 274 including a right-angled elbow 328 that is secured to second end 222b of cable 222. An annular recessed region 332 extends outwardly from elbow 328 and a tapered head 330 extends outwardly from recessed region 332. A shoulder 331a is formed at the junction of head 330 and recessed region 332. A second shoulder 331b is formed at the junction of elbow 328 and recessed region 332. The widest portion of head 330 and elbow 328 is of a width “W”. Head 330, recessed region 332 and elbow 328 preferably are generally circular in cross-sectional shape, in which case the width “W” is the diameter of the circle. Other cross-sectional shapes for these components may be utilized. The length of the portion of elbow 328 between leg 328a and second shoulder 331b is represented by “E” and the length of recessed region 332 between shoulder 331a and shoulder 331b is represented by “D”.

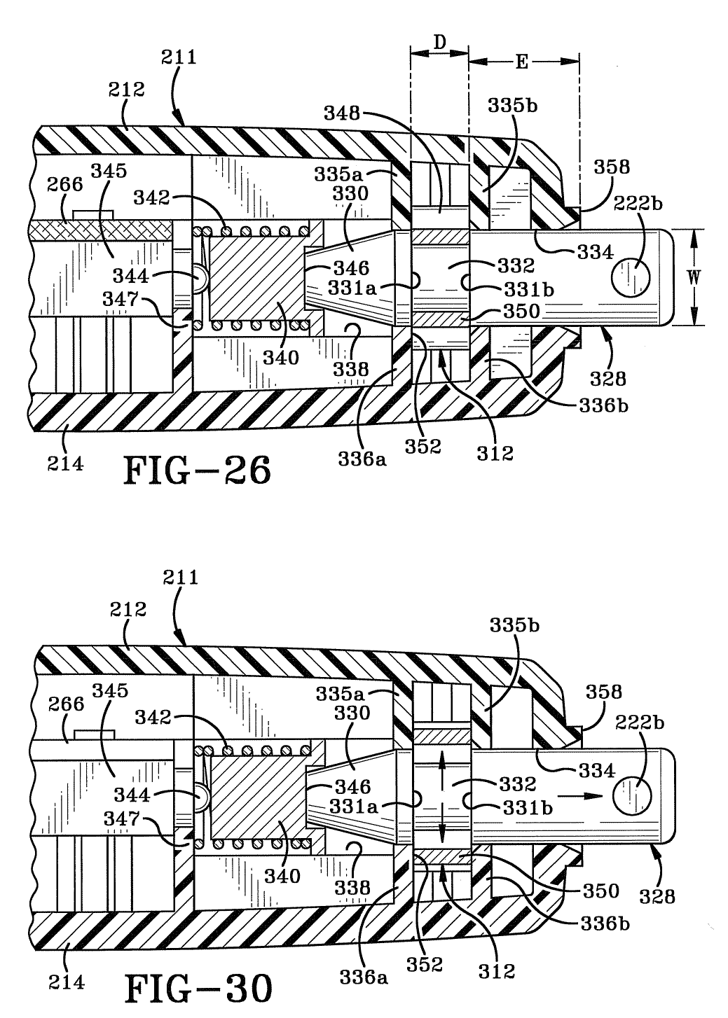

Bore 334 in housing 211 is complementary shaped and sized to receive head 330, recessed region 332 and a portion of the elbow 328 therein. Front and back 212, 214 of housing 211 are molded to form a lip 358 at the entrance to bore 334. Furthermore, a plurality of projections 335a, 335b extends inwardly from the interior surface of front 212 and a plurality of projections 336a, 336b extends inwardly from back 214. Projection 335a is aligned with projection 336a and projection 335b is aligned with projection 336b. Projections 335a, 335b terminate a distance “W” (FIG. 26) away from projections 336a, 336b, this distance being substantially equal to the width of that part of bayonet 274 inserted into bore 334. Consequently, when bayonet 274 is engaged in bore 334, the widest portion of head 330 and a portion of elbow 328 frictionally engages the tips of projections 335a, 335b, 336a, 336b. Recessed region 332 is of a diameter smaller than “W” and therefore does not contact any part of projections 335a, 335b, 336a, 336b. Furthermore, the distance between the adjacent projections 335a, 335b extending inwardly from front 212 is substantially equal to the length “D” of recessed region 332, as measured from shoulder 331a to shoulder 331b. Furthermore, the distance between an outer surface of lip 358 and an innermost surface of the projection 335b is substantially equal to the length “E” between shoulder 331b and leg 328a of elbow 328. Consequently, when bayonet 274 is inserted into bore 334, leg 328a abuts the outer surface of lip 358 and recessed region 332 falls between the pairs of projections 335a, 336a and 335b, 336b. FIG. 25 shows that a spring clip lock 312 is provided in housing 211. Spring clip lock 312 forms part of the locking mechanism 259 that will be described hereinafter. At least a portion of spring clip lock 312 is disposed in the gap between adjacent projections 335a, 335b and is designed to selectively engage recessed region 332 of bayonet 274 as will be hereinafter described.

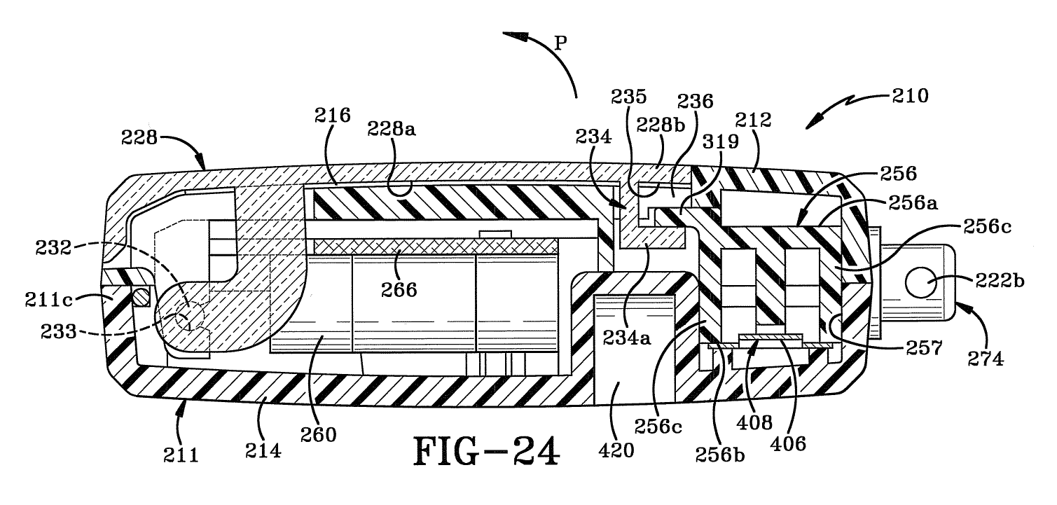

Housing 211 further defines a second chamber 338 between front 212 and back 214 thereof and adjacent the innermost pair of aligned projections 335a, 336a. Second chamber 338 houses a spring plunger 340, a spring 342 and a push pin 344 of a switch. Spring plunger 340 defines a circular recess 346 that is complementary sized to receive the tip of head 330 therein. Spring plunger 340 is movable within second chamber 338 and may be urged toward interior wall 347 thereof by head 330. In a first position (FIG. 22), spring plunger 340 is disposed adjacent projections 335a, 336a. In a second position (FIG. 23) spring plunger 340 has been forced inwardly away from projections 335a, 336a by head 330. Spring 342 is compressed and push pin 344 is moved into switch housing 345. Spring plunger 340, spring 342, push pin 344 and the switch housing 345 therefor comprise a portion of a switch mechanism for arming the alarm components within housing 211.

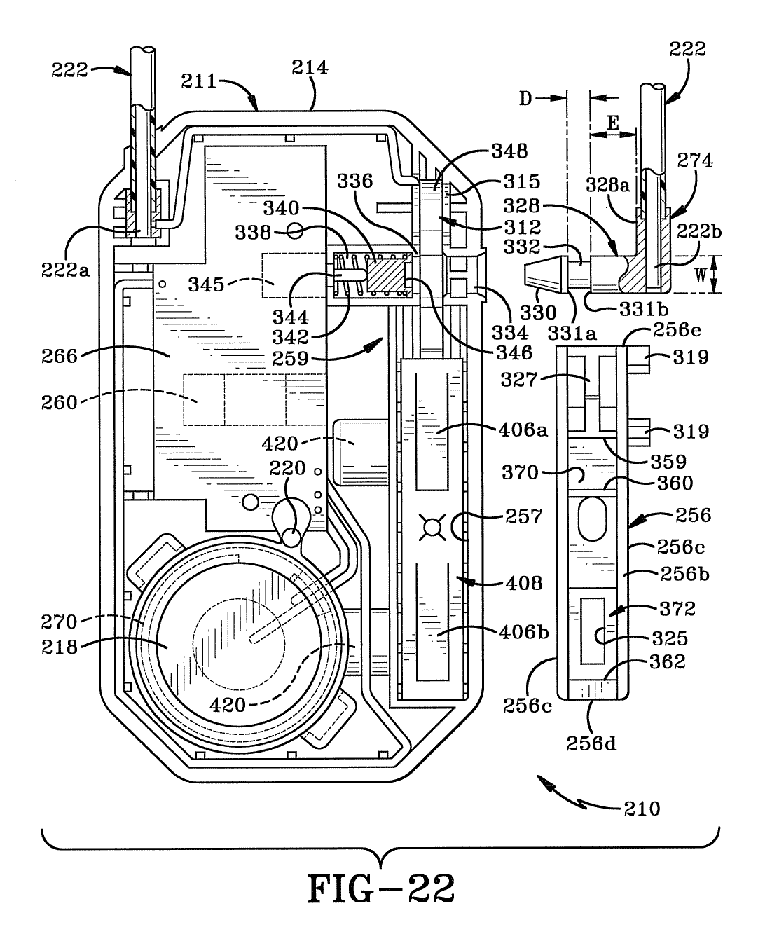

In accordance with another specific feature of the present invention, locking mechanism 259 includes a slider 256, a spring clip 408 and a clamping member. The clamping member preferably is a spring clip lock 312. Slider 256 comprises a body that is molded from a nonmagnetic material and is designed to move back and forth within a chamber 257 (FIG. 22) in housing 211. Slider 256 is shown in greater detail in FIGS. 20 & 21. Slider 256 has an upper surface 256a, an opposed lower surface 256b, side walls 256c and end walls 256d, 256e. Upper surface 256a defines a chamber 314 proximate end wall 256d. Chamber 314 includes a first wall 316, a second wall 318 and two partial walls 320, 322 that are substantially parallel to end wall 256d. Partial walls 320, 322 are disposed between first and second walls 316, 318 and extend into chamber 314, defining a gap 324 therebetween. Partial walls 320, 322 are disposed closer to second wall 318 than to first wall 316 and thereby define a smaller chamber 314a that is in communication with chamber 314. Chamber 314 retains a coil spring 310 therein and specifically retains coil spring 310 between first wall 316 and partial walls 320, 322. A sloped and textured slider button 226 extends outwardly away from upper surface 256a of slider 256 and a spaced distance from chamber 314. As shown in FIG. 17, slider button 226 projects upwardly from within the interior of housing 211 and through an aperture 227 in front 212. Slider button 226 is smaller than aperture 227 and, consequently, when engaged, slider button 226 is able to travel within aperture 227 as slider 256 moves within chamber 257. A first sloped surface 326 is formed in upper surface 256a proximate end wall 256e. First sloped surface 326 may be substantially linear or substantially arcuate when viewed in cross-section. First sloped surface 326 is disposed at an angle to the longitudinal axis of slider 256 and angles downwardly from upper surface 256a toward end wall 256e of slider body. A pair of spaced apart ledges 319 extend outwardly from upper surface 256a of slider 256 and substantially orthogonally to side walls 256c thereof. Ledges 319 extend for a distance outwardly beyond one of side walls 256c. Ledges 319 preferably are provided proximate first sloped surface 326 and remote from chamber 314.

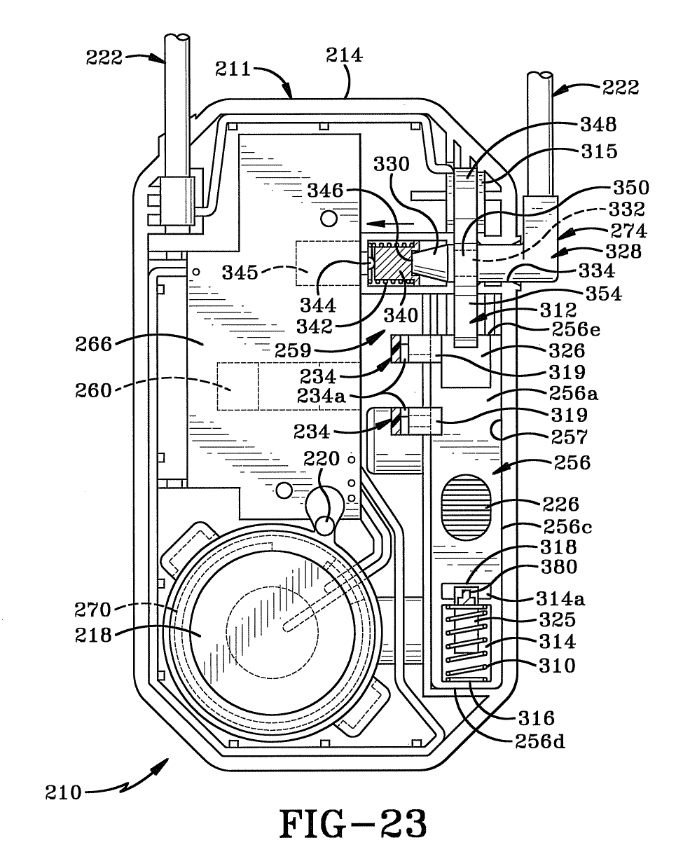

FIG. 21 shows a bottom view of slider 256. Lower surface 256b of slider 256 is molded to include a second sloped surface 327, a third wall 359 proximate an interior end of second sloped surface 327, a fourth wall 360 spaced a distance away from third wall 359, an aperture 325 defined in lower surface 256b so as to open into chamber 314, and a shoulder 362 spaced a distance from second wall 318. Second sloped surface 327 has a slope that angles from bottom surface 256c to end 256e of slider 256. A first pocket 370 is defined between third and fourth walls 359, 360. A recessed region 372 is defined between shoulder 362 and fourth wall 360. As shown in FIG. 25, first and second sloped surfaces 326, 327 slope downwardly toward end wall 256e so that slider 256 is effectively taperered toward end wall 256e. It will be understood, however, that only one of first and second sloped surfaces 327 need be angled relative to the longitudinal axis of slider 256. The other of the first and second sloped surfaces could be substantially parallel thereto. If slider 256 has only one sloped surface thereon, at least one of first and second tines 354, 356 will be forced to move away from the other as slider 256 is moved toward centering pin 315.

The second component of locking mechanism 259 is spring clip 408 (FIGS. 22, 24, 25). Spring clip 408 is substantially identical to spring clip 108, being a substantially planar member manufactured from a magnetic material. Spring clip 408 includes movable spring arms 406 that are spring-biased outwardly out of alignment with the planar member. Spring clip 408 is positioned in chamber 257 intermediate slider 256 and back 214 of housing. An end of spring arm 406a is releasably engageable with fourth wall 360 on slider 256. An end of spring arm 406b is releasably engageable with shoulder 362 on slider 256. When ends of spring arms 406a, 406b are so engaged with fourth wall 360 and shoulder 362, locking mechanism 259 is in an engaged or locked position as will be described hereinafter. When ends of spring arms 406a, 406b are not so engaged with fourth wall 360 and shoulder 362, locking mechanism 259 is in a disengaged or unlocked position.

The third component of locking mechanism 259 is the clamping member or spring clip lock 312. As shown in FIG. 25, spring clip lock 312 preferably is a hairpin type of cotter-pin made from spring steel. During manufacture, an elongate piece of spring steel is bent to form two tines 354, 356. These tines are further shaped to form a larger and substantially circular anchor region 348, a smaller substantially circular lock region 350 and two planar regions that flare outwardly away from lock region 350, terminating in tips 354a, 356a. Tines 354, 356 preferably each have at least an interior face that is substantially flattened. This flattened interior face is shown in abutting contact with recessed region 332 in FIG. 26.

Spring clip lock 312 is aligned along a longitudinal axis of slider 256. A centering pin 315 passes through circular anchor region 348 to secure spring clip lock 312 within housing. Centering pin 315 retains anchor region 348 in a substantially fixed position within housing 211 so that as the slider 256 moves toward and away from spring clip lock 312, the clip lock remains in a substantially fixed position. Lock region 350 is disposed in the gap between the pairs of aligned projections 335a, 336a and 335b, 336b extending inwardly from front 212 and back 214 of housing. Tips 354a, 356a of tines 354, 356 abut the first and second sloped surfaces 326, 327 of slider 256. First and second sloped surfaces 326, 327 are angled in such a manner that when slider 256 is moved toward centering pin 315 in the direction of arrow “S” (FIG. 25, FIG. 29), tips 354a, 356a of tines 354, 356 will slide along first and second sloped surfaces 326, 327 and move further outwardly away from each other. When this occurs, those portions of tines 354, 356 in lock region 350 move further away from each other. When slider 256 is moved in the opposite direction to arrow “S” and away from centering pin 315, tips 354a, 356a of tines 354, 356 will slide downwardly along first and second sloped surfaces 326, 327 and will move closer together.

Spring clip lock 312 is positioned and configured in such a manner that it is oriented at right angles to bore 334 and lock region 350 frames a portion of bore 334. Consequently, when bayonet 274 is inserted through bore 334, bayonet 274 is disposed at right angles to spring clip lock 312 and a portion of bayonet 274 is framed by lock region 350 of spring clip lock 312. Specifically, recessed region 332 of bayonet 274 is framed by lock region 350. As shown in FIG. 29, when slider 256 is moved in the direction of arrow “S”, tips 354a, 356a of tines 354, 356 move further away from each other and the portion of tines 354, 356 in lock region 350 do not abut recessed region 332 of bayonet 274. As shown in FIG. 25, when slider 256 is moved in the opposite direction to arrow “S”, tips 354a, 356a moves inwardly toward each other and the portion of tines 354, 356 in lock region 350 move toward each other and clamp recessed region 332 thereinbetween. It will be understood that slider 256 may, alternatively, be configured so that one of tines 354, 356 remains in a substantially fixed position while the other tine moves toward and away therefrom in response to movement of the slider.

The merchandising tag 210 of the present invention is secured to a product and alarmed in a series of steps. Price tag 216 must be inserted into first compartment 238 and the door 228 must be latched into place. Cable 222 must be passed through an appropriate region of product 224 and then bayonet 274 at the free end of cable 222 must be inserted into bore 334 in housing 211 to latch the same therein. Each of these two steps will be described separately, but it should be understood that either of the steps can be undertaken before the other without departing from the spirit of the present invention. Furthermore, both of these steps must be undertaken before merchandising tag 210 is locked and armed by engaging the locking mechanism 259 as engagement of locking mechanism 259 simultaneously locks door 228 to front 212 and locks bayonet 274 to housing 211.

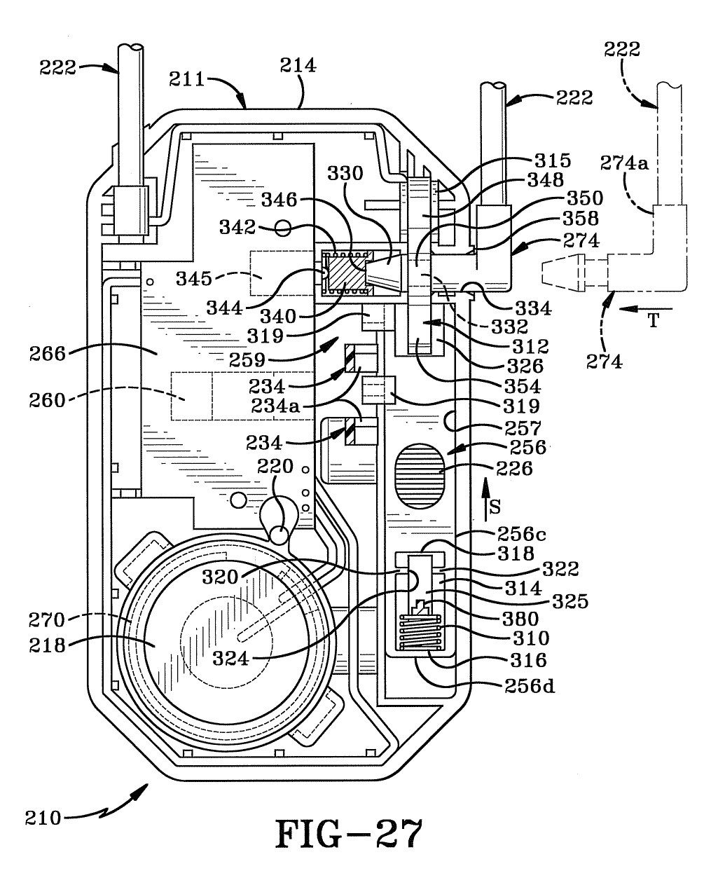

Referring to FIG. 28, price tag 216 is inserted into first compartment 238 in the following manner. Door 228 must initially be in an open position so that first compartment 238 is accessible and slider 256 of locking mechanism 259 must be in an unlocked position (FIG. 27). Price tag 216 is placed into first compartment 238 and door 228 is pivoted downwardly toward front 212 and into a closed position. As door 228 moves into the closed position, latching members 234 are received into apertures 236 on front 212 and closing off access to first compartment 238. At this point, door 228 is merely latched in place and may be reopened by applying finger pressure to the door.

Merchandising tag 210 is secured to product 224 in one of two ways. For the sake of description of the various components and their functioning, it is presumed that bayonet 274 on the free end 222b of cable 222 is initially detached from housing 211. The first way in which bayonet 274 is secured to the housing is by inserting head 330 into bore 334. Head 330 will pass through projections 335b, 336b and the tip thereof will encounter the side edge of spring clip lock 312 that is in the second lock region 350 and adjacent projections 336b, 336b. The tapered shape of head 330 causes tines 354, 356 in lock region 350 to be forced outwardly away from each other so that head 330 may slide through the same. As soon as shoulder 331a clears the opposite side edge of spring clip lock 312, tines 354, 356 revert to their original position prevent removal of head 330 from bore 334. At this point, bayonet 274 is latched into housing 334 but is not locked into place. Bayonet 274 is only locked into place by placing locking mechanism into a locked position as will be hereinafter described.

Bayonet 274 may be inserted into bore 334 in a second way. In this instance, locking mechanism 259 is in an unlocked position and slider 256 is moved into the position shown in FIGS. 27 & 29 by the user engaging slider button 226 and pushing it in the direction of arrow “S” (FIG. 29). This movement causes slider 256 to travel within the housing from the position shown in FIG. 23 to the position shown in FIG. 27. In cross-sectional view, slider 256 is moved from the position shown in FIG. 25 to the position shown in FIG. 27. The movement in the direction of arrow “S” causes tines 354, 356 of spring clip lock 312 to ride outwardly away from each other along first and second sloped surfaces 326, 327 of slider 256. This, in turn, causes the portion of tines 354, 356 in the lock region 350 to be moved sufficiently far enough away from each other that head 330 of bayonet 274 is able to pass therebetween. It should be noted that as slider 256 is moved into this disengaged position, spring 310 is compressed between first wall 316 of chamber 314 and a buttress 380 extending downwardly from an interior surface of housing front 212. The user has to maintain pressure on button 226 in order to substantially prevent slider 256 from moving back to its original position within the housing under the recoil of spring 310. Furthermore, as slider 256 advances in the direction of arrow “S” within housing 211, tips 354a, 356a of tines 354, 356 on spring clip lock 312 ride along first and second sloped surfaces 326, 327 of slider 256. This is illustrated in FIG. 29 where it can be seen that tines 354, 356 in the lock region 350 are forced away from each other. This effectively enlarges the diameter of the lock region 350 to a size that is greater than the widest portion of head 330. When head 330 of bayonet 274 slides through the gap between projections 335a, 335b and 336a, 336b and between tines 354, 356, the tip of the head 330 enters second chamber 338 and becomes seated in recess 346 on spring plunger 340 (FIG. 26). Continued movement of head 330 into second chamber causes spring plunger 340 to be moved inwardly within second chamber 338 and toward interior wall 347. Moving spring plunger 340 in this manner causes spring 342 to be compressed against interior wall 347 of second chamber 338 and also forces push pin 344 back into switch housing 345. When leg 328a of elbow 328 strikes lip 358 at exterior opening to bore 334, movement of bayonet 274 into bore 334 is arrested. At this point, recessed region 332 of bayonet 274 is disposed in the gap between the pairs of adjacent projections 335a, 336a and 335b, 336b and in the vicinity of lock region 350 of spring clip lock 312. However, because slider 256 is in the position shown in FIG. 29, tines 354, 356 are spaced a distance outwardly away from recessed region 332 and bayonet 274 is merely latched within bore 334 and can be withdrawn therefrom.

Since the locking mechanism 259 is biased into a locked condition, all the user has to do to lock the locking mechanism is to release slider button 226. The release of pressure on slider 256 allows compressed spring 310 to rebound to its original length and position within chamber 314. As it does so, slider 256 is drawn in the opposite direction to arrow “S” until buttress 380 becomes wedged between partial walls 320, 322. Buttress 380 may extend partially into small chamber 314a. This movement of slider 256 causes tips 354a, 356a of tines 354, 356 that abut first and second sloped surfaces 326, 327 to slide downwardly therealong and toward end 256e. Tips 354a, 356a therefore move closer to one another. As they do so, the portions of tines 354, 356 in lock region 350 adjacent recessed region 332 are moved inwardly toward each other to the point that they abut recessed region 332. As shown in FIG. 25, recessed region 332 becomes tightly clamped between tines 354, 356 in lock region 350. Bayonet 274 is thereby locked into place in bore 334 and cannot be withdrawn therefrom. The locking of bayonet 274 in this position closes some of the electrical circuits that pass through cable 222. If cable 222 is cut or a serious attempt is made to remove bayonet 274 from bore 334, the circuits will be broken and one or more of the alarms will be triggered.

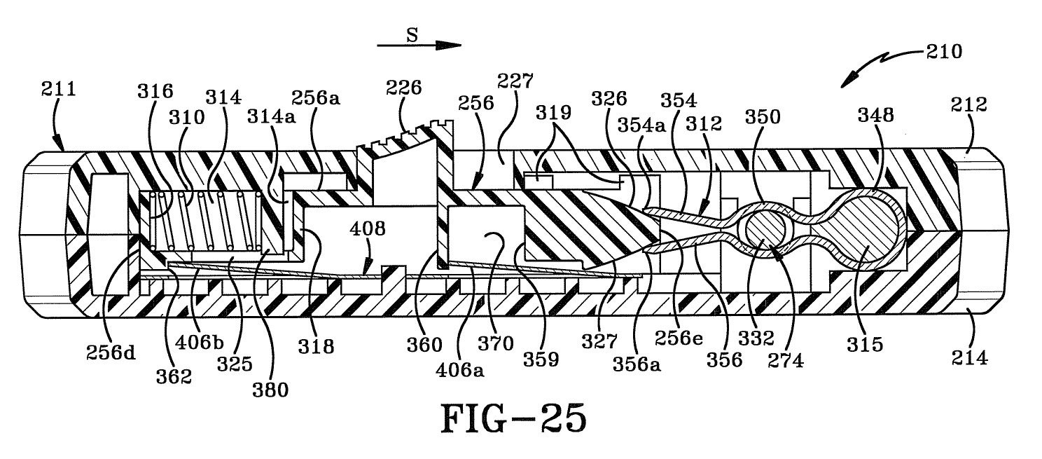

Consequently, at the same time that bayonet 274 is locked into bore 334, slider 256 has moved in the direction of arrow “S” from the position shown in FIG. 27 to the position shown in FIG. 23. Ledges 319 on slider 256 have therefore moved with slider 256 away from centering pin 315. FIG. 23 shows ledges 319 being disposed proximate legs 234a of latching members 234. FIG. 24, shows ledge 319 disposed in gap 235 between leg 234a of latching member 234 and end region 228b of door 228. In this position, ledges 319 lock legs 234a of latching members 234 in place and substantially prevent door 228 from being pivoted into an open position. The sliding of slider 256 within housing therefore simultaneously locks bayonet 274 into bore 334 and locks latching members 234 into apertures 236. The movement of the slider also closes the electrical alarm circuits that will be broken if door 228 is pried open and is pivoted into an open position. Furthermore, as slider 256 is moved in the opposite direction to arrow “S”, the lower surface 256b thereof moves over spring clip 408 to the point that spring arms 406a, 406b are adjacent first pocket 370 and recessed region 372. Spring arms 406a, 406b are no longer forced to remain coplanar with the remaining part of spring clip 408 and, as they are spring biased, spring arms 406a, 406b rebound to the biased position. Consequently, the end of spring arm 406a abuts an interior portion of fourth wall 360 on slider 256 and spring arm 406b abuts shoulder 362 on slider 256. Any attempt to move slider 256 back in the direction of arrow “S” will be resisted by spring arms 406a, 406b. Spring arms 406 of spring clip 408 therefore lock spring clip 408 in place and therefore force tines 354, 356 of spring clip lock 312 in abutting contact with bayonet 274. Even downward pressure on slider button 226 will not be sufficient to force spring arms 406 back into coplanar alignment with the remaining part of spring clip 408.

All of the interior components of merchandising tag 210 are thus fixedly locked into place and cannot be moved in any way that will disengage the locking mechanism 259. Furthermore, tampering with one or more of the accessible components of the device will cause a break in the electrical circuits and consequently triggering of one or more alarm components.

The merchandising tag 210 of the present invention is deactivated and released from product 224 in a reverse series of steps to those described above. In order to disengage locking mechanism 259, key 416 must be used to unlock locking mechanism 259 and to place it in condition to permit slider 256 to be moved within housing 211 once again. Key is engaged with merchandising tag 210 by inserting projections (not shown) on key 416 into alignment holes 420 (FIG. 18) on back 214 of housing. This positions magnets 419 within key 416 appropriately to attract movable spring arms 406a, 406b of spring clip 408 back into coplanar alignment with the planar portion thereof. The engagement of key 416 is substantially identical to the engagement of key 116 with spring clip 108 in the first embodiment of merchandising tag 10. Once movable spring arms 406a, 406b are aligned with the planar portion of spring clip 408, the user engages slider button 226 on front 212 of tag 210 and pushes the same toward centering pin 315 in the direction of arrow “S”. Tines 354, 356 move apart from each other to the position shown in FIG. 29. The recessed region 332 of bayonet 274 is no longer captured between tines 354, 356 and bayonet 274 may be withdrawn from bore 334. Additionally, as slider 256 moves forward, ledges 319 thereon slide toward centering pin and out of gap 235 between leg 234a of latching member and end region 228b of door 228. Consequently, leg 234a is no longer restrained against upward movement and finger pressure may be applied to door 228 to pivot it in the direction of arrow “P” and into an open position. Movement of slider 256 in the direction of arrow “S” therefore simultaneously unlocks door 228 and bayonet 274 and disarms alarm components. Door 228 may be opened and bayonet 274 removed from bore 334 in whatever order is desired. If price tag 216 is to be replaced and merchandising tag 210 is to remain attached to product 224 during this change, the door 228 is opened by application of finger pressure, price tag 216 is exchanged for a new price tag (not shown), door 228 is pushed back into a closed position and locking mechanism 259 is moved from a disengaged to an engaged position as previously described. This simultaneously locks door 228 and bayonet 274 and activate alarms in tag 210.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A merchandising tag for a product, the tag comprising:
a housing;
a cable adapted to engage a product, said cable having a first end fixedly secured to the housing and a second free end that is releasably engageable with the housing;
a bore defined in an exterior wall of the housing, said bore being configured to receive the free end of the cable therein;
a compartment defined in the exterior wall and adapted to receive a price tag therein;
a door mounted on the exterior wall and being movable between a closed position where it covers the compartment and an open position where it does not cover the compartment;
a locking mechanism disposed within the housing and being moveable between a locked position, where the locking mechanism simultaneously locks the door and the free end of the cable to the housing, and an unlocked position where the locking mechanism simultaneously releases the door and the free end of the cable; and when in the locked position said locking mechanism clampingly engages the free end of the cable.

2. The merchandising tag as defined in claim 1, wherein the locking mechanism includes a clamping member disposed substantially at right angles to the bore in the housing, and the clamping member engages a portion of the free end of the cable substantially at right angles when the free end is received in the bore.

3. The merchandising tag as defined in claim 2, wherein the clamping member comprises a hairpin-type cotter pin having:
a first tine and a second tine disposed one above the other; and wherein at least one of said first and second tines is movable toward the other to clampingly engage the portion of the free end of the cable therebetween; and wherein the at least one of the first and second tines is movable away from the other to release the portion of the free end of the cable.

4. The merchandising tag as defined in claim 3, wherein a section of each of the first and second tines is shaped to form:
a lock region that substantially circumscribes the bore, whereby the sections of the first and second tines in the lock region move toward each other to clamping engage the portion of the free end of the cable when the locking mechanism is in the locked position.

5. The merchandising tag as defined in claim 4, wherein the first and second tines are further shaped to form:
an anchor region spaced a distance from the lock region in a first direction; and
a pair of planar tips extending outwardly in a second direction from the lock region.

6. The merchandising tag as defined in claim 5, wherein the locking mechanism further comprises:
a slider that is selectively movable within the housing in a first direction toward the clamping member and in a second direction away from the clamping member, wherein said slider has a first end proximate the clamping member and a second end remote from the clamping member and a longitudinal axis extending therebetween, and wherein the first and second tines of the clamping member are substantially aligned with the longitudinal axis of the slider.

7. The merchandising tag as defined in claim 6, wherein the slider includes:
a first surface sloped at an angle to the longitudinal axis of the slider, said first sloped surface tapering downwardly toward the first end, and
a second surface disposed a distance from the first sloped surface, and wherein the first tine of the clamping member abuts the first sloped surface and the second tine abuts the second surface, and when the slider is moved longitudinally in the first direction, the first tine rides upwardly along the first sloped surface whereby the first and second tines move a spaced distance away from each other; and when the slider is moved in the second direction, the first tine rides downwardly along the first sloped surface and the first and second tines move toward each other.

8. The merchandising tag as defined in claim 7, wherein the second surface is sloped at an angle to the longitudinal axis and in a direction opposite to the angle of the first sloped surface, and when the slider is moved in the first direction the second tine rides downwardly along the second sloped surface thereby moving the first and second tines away from each other, and when the slider is moved in the second direction, the second tine rides upwardly along the second sloped surface, thereby moving the first and second tines toward each other.

9. The merchandising tag as defined in claim 6, wherein the locking mechanism further comprises:
a spring clip disposed within the housing in abutting contact with the slider; and when the locking mechanism is in the locked position, the spring clip substantially prevents movement of the slider in the first direction; and wherein the spring clip is adapted to be selectively engaged by a complementary key thereby unlocking the locking mechanism and permitting movement of the slider in the first direction.

10. The merchandising tag as defined in claim 9, wherein the spring clip comprises:
a planar member; and
at least one movable spring arm biased to extend outwardly from the planar member and at an angle thereto, and wherein said spring arm deflects to engage a shoulder on the slider and said deflected spring arm substantially prevents the slider from moving in the first direction when so engaged.

11. The merchandising tag as defined in claim 10, further comprising a magnetic key that is selectively engageable with the housing to cause the at least one spring arm to be aligned with the planar member thereby releasing the slider to be movable in the first direction.

12. The merchandising tag as defined in claim 6, wherein the locking mechanism further comprises a spring engaged with the slider to urge the slider in the second direction.

13. The merchandising tag as defined in claim 12, wherein the slider has an interior wall that defines a longitudinally aligned cavity and the spring is disposed within the cavity, and wherein the housing includes a buttress that projects into the cavity in the slider, and wherein movement of the slider in the first direction causes the spring to be compressed between the buttress and the interior wall of the slider.

14. The merchandising tag as defined in claim 6, wherein the slider has an outer surface that includes an outwardly projecting button, and the housing defines an aperture through which the button extends, and wherein the button is adapted to be contacted by a user to move the slider in the first direction to unlock the locking mechanism; and when the button is released, the slider moves in the second direction.

15. The merchandising tag as defined in claim 6, wherein said door includes a latching member; and
the exterior wall of the housing defines an aperture therein, said aperture being configured to receive the latching member therein when the door is in the closed position; and wherein the lock region of the locking mechanism engages the latching member when the locking mechanism in a locked position and substantially prevents the door from being moved from a closed position to an open position.

16. The merchandising tag as defined in claim 15, wherein the latching member comprises an L-shaped projection extending inwardly from an interior surface of the door, said projection including a first leg disposed at right angles to the interior surface of the door and a second leg disposed substantially parallel to the interior surface thereof whereby a gap is defined between the interior surface and the second leg; and wherein said at least one ledge is received within the gap when the locking mechanism is in the locked position, whereby the ledge substantially prevents the door from being moved from the closed position to the open position.

17. The merchandising tag as defined in claim 1, further comprising a magnetic key having a projection extending outwardly away from an exterior surface thereof, and wherein said housing defines a complementary hole into which said projection is insertable; and when so inserted, said key releases the locking mechanism so that the locking mechanism may be moved from the locked position to the unlocked position, and when the key is not so engaged with the housing, the locking mechanism cannot be moved from the locked position to the unlocked position.

18. The merchandising tag as defined in claim 4, wherein the free end of the cable includes a bayonet connector, said connector comprising:
a body fixedly secured to the free end of the cable;
a tapered head that extends outwardly away from the body; and
a recessed region disposed intermediate the head and the body; and wherein the head, the recessed region and a portion of the body is received within the bore of the housing.

19. The merchandising tag as defined in claim 17, wherein the housing further defines a second chamber disposed adjacent to and aligned longitudinally with the bore; and wherein the tapered head of the bayonet connector extends into the second chamber when said bayonet connector is engaged in the bore.

20. The merchandising tag as defined in claim 19, further comprising:
a spring plunger housed within the second chamber, said spring plunger having a first end surface disposed adjacent the bore and an opposing second end surface remote from the bore; said spring plunger being longitudinally movable within the second chamber when the first end surface thereof is contacted by the tapered head of the bayonet connector.

21. The merchandising tag as defined in claim 20, further comprising;
a coil spring disposed between the second end surface of the spring plunger and an interior wall of said second chamber; and wherein said spring biases said spring plunger toward said bore; and when said bayonet connector is received through the bore and the tapered head thereof engages the first end surface of the spring plunger, the spring is compressible between the second end surface and the interior wall of the second chamber.

22. The merchandising tag as defined in claim 21, further comprising:
a switch disposed within the housing adjacent the second chamber, said switch being adapted to be operationally connected to an alarm component retained within the housing;
a push pin extending outwardly from switch and into engagement with the second end surface of the spring plunger; said push pin being compressible by the spring plunger to activate the switch to arm the alarm component.
